(19) United States
(12) Patent Application Publication
(10) Pub. No.: US 2016/0179194 A1
(43) Pub. Date: Jun. 23, 2016

(54) DISPLAY DEVICE AND DRIVING METHOD THEREOF

(71) Applicant: Samsung Display Co., Ltd., Yongin-si (KR)

(72) Inventor: Il-Nam KIM, Yongin-si (KR)

(21) Appl. No.: 14/849,161

(22) Filed: Sep. 9, 2015

(30) Foreign Application Priority Data
Dec. 17, 2014 (KR) 10-2014-0182605

(51) Int. Cl. G06F 3/01; G09G 3/20; G06K 9/00

(52) U.S. Cl. CPC G06F 3/013; G06K 9/00604; G09G 3/20

(57) ABSTRACT

A method of driving a display device, including: counting the number of times of input of a user event; calculating an event input rate defined as the number of times of input of the user event per unit time; and displaying a subliminal image when the event input rate is equal to or greater than a first reference value.

### CROSS-REFERENCE TO RELATED APPLICATION

This application claims priority from and the benefit of Korean Patent Application No. 10-2014-0182605, filed on Dec. 17, 2014, which is hereby incorporated by reference for all purposes as if fully set forth herein.

### BACKGROUND

1. Field

Exemplary embodiments relate to a display device and a driving method thereof.

2. Discussion of the Background

A “subliminal effect” relates to a theory stating that the subconsciousness of human beings may be influenced by a sound or an image which human beings cannot easily recognize. A subliminal technique based on an application of the theory may induce a specific action or feeling from a person, and is applicable to a medical device, a sound device, a display device, and the like for the purpose of treatment or advertisement.

In a display field, in order to prevent xerophthalmia generated by a “Video Display Terminal” (VDT) syndrome, a method of inducing eye blink of a user by adopting the subliminal technique has been studied.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a method of driving a display device to display a subliminal image.

Additional aspects will be set forth in the detailed description which follows, and, in part, will be apparent from the disclosure, or may be learned by practice of the inventive concept.

An exemplary embodiment of the present invention discloses a method of driving a display device, including: counting the number of times of input of a user event; calculating an event input rate defined as the number of times of input of the user event per unit time; and displaying a subliminal image when the event input rate is equal to or greater than a first reference value.

An exemplary embodiment of the present invention also discloses a display device, including: a display unit; a user input unit configured to generate a user event; and a subliminal driver configured to count the number of times of input of the user event, calculate an event input rate that is the number of times of input of the user event per unit time, and display a subliminal image on the display unit when the event input rate is equal to or greater than a first reference value.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a schematic block diagram of a display device according to an exemplary embodiment of the present invention.

FIG. 2 is a flowchart illustrating a method of driving the display device according to an exemplary embodiment of the present invention.

FIG. 3A, FIG. 3B, FIG. 3C, and FIG. 3D are diagrams illustrating examples of a subliminal image.

FIG. 4A, FIG. 4B, FIG. 5A, and FIG. 5B are diagrams for describing a method of displaying a subliminal image.

FIG. 6 is a flowchart illustrating a method of setting a reference value by analyzing an eye blink pattern according to an exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

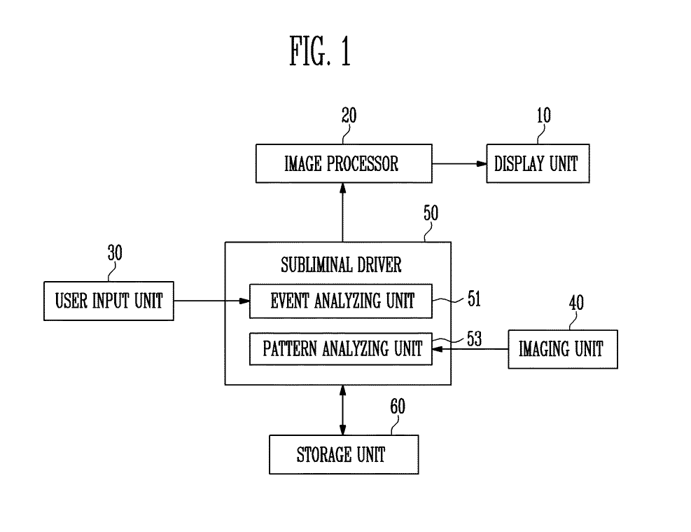

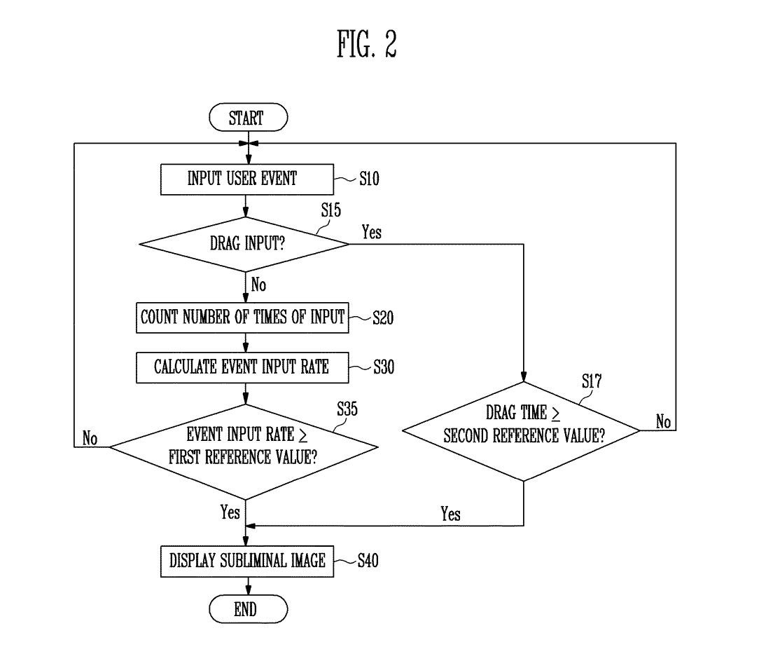

FIG. 1 is a schematic block diagram of a display device according to an exemplary embodiment of the present invention, and FIG. 2 is a flowchart illustrating a method of driving the display device according to an exemplary embodiment of the present invention.

A display device of the exemplary embodiments of the present invention may be an electronic device for displaying an image or performing image processing. For example, the display device may be a cellular phone, a smart phone, table computer, a Personal Digital Assistant (PDA), a Portable Multimedia Player (PMP), a digital camera, a music player, a portable game console, a navigation system, a Personal Computer (PC), a laptop computer, a server computer, a workstation, a digital television (TV), or a set-top box, or a system including at least one thereof.

Referring to FIG. 1, the display device according to an exemplary embodiment of the present invention may include a display unit 10, an image processor 20, a user input unit 30, an imaging unit 40, a subliminal driver 50, and a memory unit 60.

The display unit 10 displays an image processed by the image processor 20. The display unit 10 may include a display panel (not illustrated) implemented in a form of a Liquid Crystal Display (LCD), an Organic Light Emitting Diode (OLED), or a Plasma Display Panel (PDP), and a panel driver (not illustrated) for driving the display panel.

In some exemplary embodiments, the display unit 10 may be a touch screen panel integrated display device. In this case, the display unit 10 may have a predetermined touch recognition region for detecting a contact of a body of a user or a pointing device. The kind, position, form, and size of the display unit 10 may be varied as necessary, and the present invention is not limited thereto.

The image processor 20 may process an image (hereinafter referred to as a “normal” image) and display the processed image on the display unit 10. Here, the normal image may be a TV program image broadcasted from a broadcasting station, an image reproduced from pre-stored image data, or an image of an application executed in the display device. The image processor 20 may perform at least one of decoding, scaling, frame rate conversion, brightness control, contrast control, light and shade control, and image enhancement.

The user input unit 30 is a device in which a user event is generated. The user input unit 30 may include at least one of a touch pad, a touch screen, a keyboard, and a mouse. The user event is a control operation of a user through the user input unit 30 or an input signal corresponding to the control operation. That is, the user event may include at least one of a touch input through a touch screen, a keyboard input through a keyboard, and a mouse input through a mouse. The user input unit 30 may be integrally included in the display device, or be separately provided to be connected with the display device. The user input unit 30 may include various other kinds of input means controllable by a user, and the present invention is not limited thereto.

The imaging unit 40 is a device for obtaining an image of a user. The imaging unit 40 may be embedded in the display device, or be separately provided to be connected with the display device. For example, the imaging unit 40 may be an embedded camera of a smart phone, or a camcorder mounted in a TV or a monitor.

The subliminal driver 50 is configured to display a subliminal image for inducing eye blink on the display unit 10 in order to prevent xerophthalmia of a user. In particular, the subliminal driver 50 counts the number of times of input of a user event, and calculates an event input rate that is the number of times of input of the user event per unit time. Further, when the event input rate is equal to or greater than a first reference value, the subliminal driver 50 controls the image processor 20 so that the subliminal image is displayed on the display unit 10. That is, the subliminal driver 50 determines concentration of a user, and when the concentration is increased, the subliminal driver 50 produces the subliminal image. To this end, the subliminal driver 50 may include an event analyzing unit 51 for analyzing the user event and determining a condition under which the subliminal image is produced.

The memory unit 60 may store subliminal image data, information about a driving condition of the subliminal image, a user event, information on an event input rate, and the like.

Referring to FIG. 2, a user event is input to the subliminal driver 50 through the user input unit 30 (S10). Here, the user event is a control operation of a user through the user input unit 30 or an input signal corresponding to the control operation. That is, the user event may include at least one of a touch input through a touch screen, a keyboard input through a keyboard, and a mouse input through a mouse.

Next, the subliminal driver 50 counts the number of times of input of the user event (S20). When there is no input of the user input while the subliminal driver 50 counts the number of times of input, the subliminal driver 50 may initialize the number of times of input. For example, when the touch is continuously input 10 times, and then there is no subsequent touch input for one minute, the number of times of input may be initialized to 0. Here, the kind and the number of times of input of the user event may be stored in the memory unit 60.

Next, the subliminal driver 50 calculates an event input rate that is the number of times of input of the user event per unit time. Further, the subliminal driver 50 determines whether the event input rate is equal to or greater than a first reference value (S35). For example, when the first reference value is 100 times per minute, the subliminal driver 50 may calculate the number of times of touch input per minute, and determine whether the number of times of touch input per minute is equal to or greater than 100.

In operation S35, when the event input rate is equal to or greater than the first reference value, the subliminal driver 50 controls the image processor 20 so that the subliminal image is displayed, and when the event input rate is less than the first reference value, the subliminal driver 50 returns to operation S10 (S40). Here, the first reference value may be preset, and the subliminal image may be an image for inducing eye blink of the user. For example, when the first reference value is 100 times per minute and the number of times of touch input per minute is equal to or greater than 100, the subliminal driver 50 displays the subliminal image for inducing eye blink on the display unit 10.

That is, the subliminal driver 50 determines an excessive concentration state of the user based on the large number of times of touch input. For example, when the user plays a game through a smart phone, the number of times of touch input may be considerably increased, and in this case, the number of times of eye blink is noticeably decreased. When such a state is maintained for a long time, the user may have xerophthalmia, so that the subliminal driver 50 induces unconscious eye blink of the user by driving the subliminal image.

In one exemplary embodiment, the first reference value for determining an excessive concentration state of the user may be calculated by an experimental/statistical method and pre-set in a manufacturing stage of the display device. In another exemplary embodiment, the first reference value may be set to other values or varied according to a user, which will be described below.

In the meantime, operations S15 and S17 may be selectively added to the aforementioned exemplary embodiments. The subliminal driver 50 may determine whether the user event is a drag input (S15). The “drag input” refers to an operation of pulling a pointer and moving a target on a user interface. For example, the drag input is an operation of moving a finger to another position in a state where the finger touches onto a touch screen and then detaching the finger, or moving a mouse in a state where a mouse button is pressed and then releasing the press of the mouse button.

When the user event is the drag input in operation S15, it is determined whether a drag time, for which the drag input is maintained, is equal to or greater than a second reference value (S17). When the drag time, for which the drag input is maintained, is equal to or greater than the second reference value, the subliminal driver 50 controls the image processor 20 so that the subliminal image is displayed (S40).

For example, when the second reference value is one minute, and the drag time is equal to or greater than one minute, the subliminal driver 50 displays the subliminal image for inducing eye blink on the display unit 10. That is, the subliminal driver 50 may determine the excessive concentration state of the user based on the long drag time. For example, when the user plays a game through a smart phone, the drag time may be increased, and in this case, the number of times of eye blink is noticeably decreased. When such a state is maintained for a long time, the user may have xerophthalmia, so that the subliminal driver 50 induces unconscious eye blink of the user by producing the subliminal image.

In one exemplary embodiment, the second reference value for determining the excessive concentration state of the user may be calculated by an experimental/statistical method and pre-set in a manufacturing stage of the display device. In another exemplary embodiment, the second reference value may be set to other values or varied according to a user, which will be described below.

According to exemplary embodiments of the present invention, the subliminal image is displayed when the number of times of input of the user event per unit time is equal to or greater than the reference value, thereby deriving concentration of the user with a simple algorithm and implementing a subliminal function.

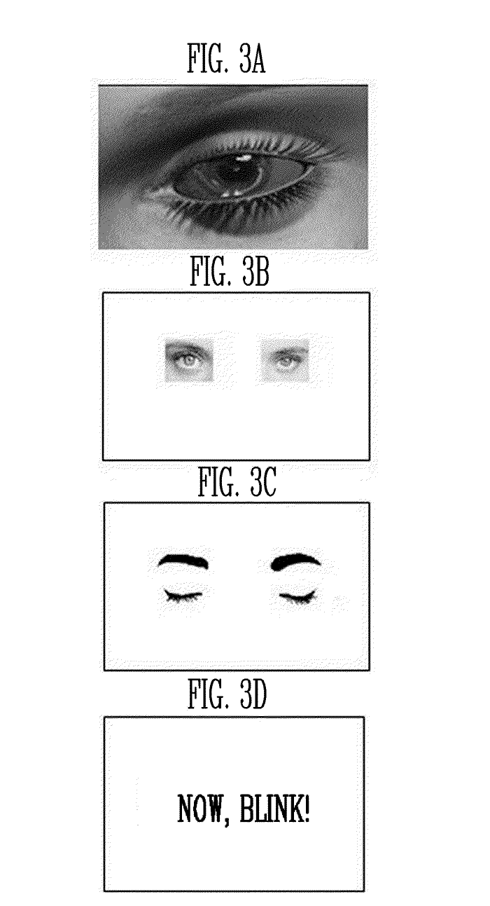

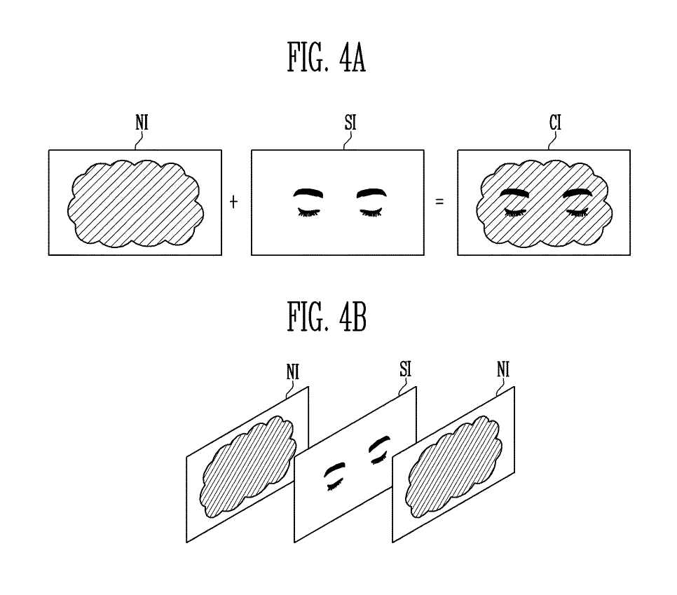

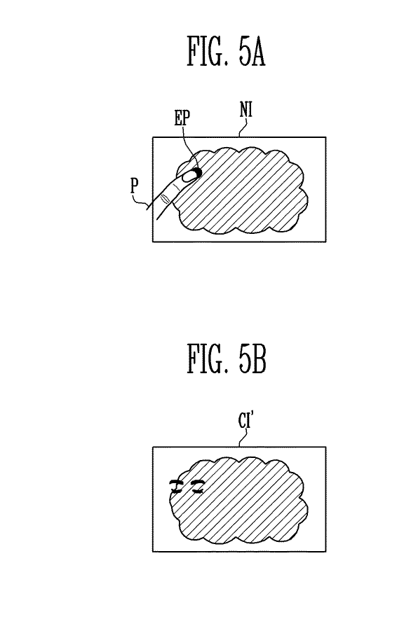

FIGS. 3A to 3D are diagrams illustrating examples of a subliminal image, and FIGS. 4A, 4B, 5A, and 5B are diagrams for describing a method of displaying a subliminal image.

Referring to FIGS. 3A to 3D, the subliminal image is an action inducing image for inducing a predetermined action of a user, and may be an eye blink inducing image for inducing eye blink of a user. For example, the subliminal image may be an image of one eye, an image of both eyes, or an image of both closed eyes. Otherwise, the subliminal image may be a character directing eye blink. The eye blink inducing image may induce eye blink of the user through an agreement effect or subliminal learning.

Referring to FIGS. 4A and 4B, the display device may display a combined image CI, in which a subliminal image SI overlaps or is combined with a normal image NI, or the display device may display the subliminal image SI by replacing the normal image NI. For example, the display device may insert a subliminal image SI frame or a combined image CI frame thereof between the normal image NI frames for each predetermined period and display the subliminal image SI or the combined image CI thereof. In one exemplary embodiment, the subliminal image SI or the combined image CI thereof may be periodically displayed at a predetermined maintenance time. For example, the subliminal image SI may be displayed at an interval of about four seconds. In another exemplary embodiment, at least one of the period (or time interval) and the maintenance time (or the time for which the subliminal image SI or the combined image CI is continuously displayed) of the subliminal image SI or the combined image CI may be varied.

In one exemplary embodiment, the subliminal image SI or the combined image CI may be displayed for a shorter time than a time recognizable by the user. For example, the eye blink inducing image may be displayed only for one frame for each predetermined period. In this case, the eye blink inducing image is not consciously recognized by the user, thereby causing no displeasure to the user. However, the eye blink inducing image may be provided to the user as subliminal stimulation, and induce an action, for example, eye blink, of the user, by an agreement effect or subliminal learning.

Referring to FIGS. 5A and 5B, the display device may display a subliminal image SI or a combined image CI′ on a predetermined region or an event generation region EP, in which a user event is generated, on a screen. For example, the display device may detect touch coordinates generated by a finger P of the user on the touch screen, and extract an event generation region EP in a region, in which the normal image NI is displayed, based on the detected touch coordinates. Further, the display device may display the combined image CI′ combined with the subliminal image SI on the event generation region EP.

In another exemplary embodiment, the display device may detect pointer coordinates of a mouse, and extract an event generation region EP in a region, in which a normal image is displayed, based on the detected pointer coordinates. In yet another exemplary embodiment, the region, in which the subliminal image SI is displayed, may be preset as a specific position, for example, a center region of the screen. It is highly likely that the eyes of a user are located in the event generation region EP and the center region of the screen, so that an effect of the subliminal image SI may be improved. However, the region, in which the subliminal image SI or the combined image CI′ is located, may be appropriately set to the user or may be varied, and the present invention is not limited thereto.

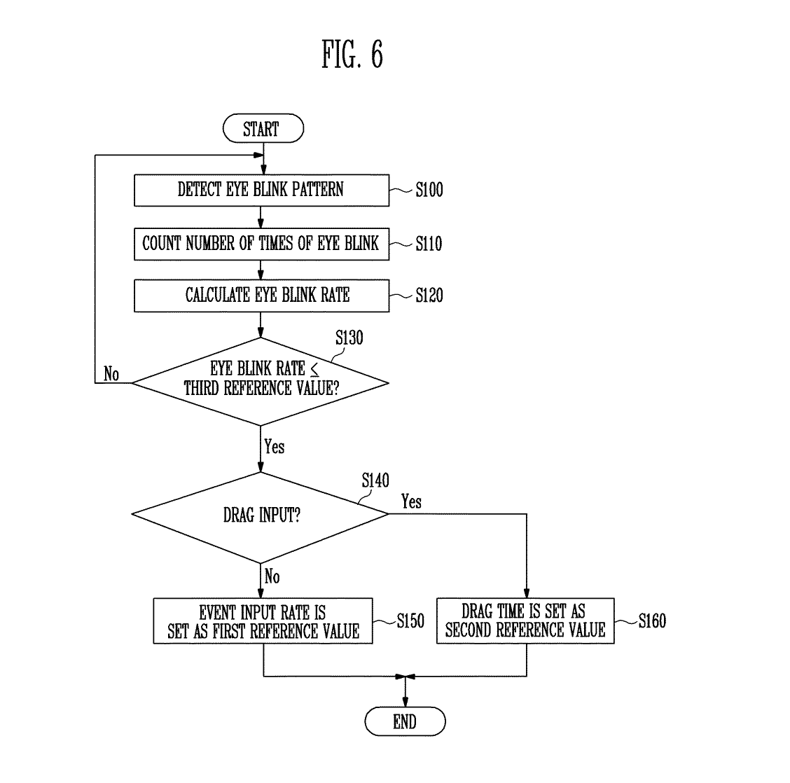

FIG. 6 is a flowchart illustrating a method of setting a reference value by analyzing an eye blink pattern according to an exemplary embodiment of the present invention.

Referring to FIG. 6, the display device according to the exemplary embodiment of the present invention may detect an eye blink pattern of a user by using the imaging unit 40 (S100). Here, the detection of the eye blink pattern may mean detecting at least one of a period of eye blink (that is, a time interval between eye blink) and a blink duration time (that is, a time between a start of eye blink and a completion of eye blink).

The display device may count the number of times of eye blink based on the detected eye blink pattern (S110). Further, the display device may calculate an eye blink rate that is the number of times of eye blink per unit time (S120). For example, the eye blink rate may be the number of times of eye blink per minute.

The display device determines whether the eye blink rate is equal to or less than a third reference value (S130). For example, when the third reference value is set to 15 times per minute, the display device may determine whether the eye blink rate is equal to or less than 15 times per minute in real time. Here, the third reference value may be set to a minimum eye blink rate at which xerophthalmia is prevented. When the eye blink rate exceeds the third reference value in operation S130, the display returns to operation S100. Optionally, the display device may determine whether a current input user event is a drag input (S140).

When the eye blink rate is equal to or less than the third reference value in operation S130, and the user event is not the drag input in operation S140, the display device may set an event input rate calculated based on a time at which the eye blink rate is decreased to the third reference value or lower, as the first reference value (S150). However, it is assumed that the event input rate is calculated in real time.

For example, when the third reference value is 15 times per minute and the currently recognized eye blink rate is equal to or less than 15 times per minute, the number of times of touch input per minute of 80 that is the currently calculated event input rate may be set as the first reference value. That is, when the number of times of touch input per minute of the user exceeds 80 times, the display device may estimate that the eye blink pattern has a pattern in which the number of times of eye blink is excessively decreased. Accordingly, a driving condition of the subliminal image inducing eye blink is set based on the estimated eye blink pattern.

As described above, a subliminal image driving condition is determined based on the eye blink pattern of a user, and an eye blink inducing image is displayed according to the subliminal image driving condition, thereby performing subliminal driving considering a characteristic of a user, and decreasing displeasure of a user compared to a case where the eye blink inducing image is displayed under the same condition.

In another exemplary embodiment, the display device may store a plurality of elements of information on an event input rate at a time at which the eye blink rate is decreased to the third reference value or less, and set an average value of the plurality of event input rates as the first reference value. Accordingly, it is possible to improve appropriateness and reliability of the subliminal driving condition corresponding to the eye blink pattern of the user.

In the meantime, when the eye blink rate is equal to or less than the third reference value in operation S130, and the user event is the drag input in operation S140, the display device may set a drag time, for which the drag input is maintained, based on a time at which the eye blink rate is decreased to the third reference value or less, as the second reference value (S160). However, it is assumed that the drag time is calculated in real time.

For example, when the third reference value is 15 times per minute and the currently recognized eye blink rate is equal to or less than 15 times per minute, the currently calculated drag time of 50 seconds may be set to the second reference value. That is, when the drag time of the user exceeds 50 seconds, the display device may estimate that the eye blink pattern has a pattern in which the number of times of eye blink is excessively decreased. Accordingly, a driving condition of the subliminal image inducing eye blink is set based on the estimated eye blink pattern.

In yet another exemplary embodiment, the display device may store a plurality of elements of information on a drag time at a time at which the eye blink rate is reduced to the third reference value or less, and set an average value of the plurality of event drag times as the second reference value. Accordingly, it is possible to improve appropriateness and reliability of the subliminal driving condition corresponding to the eye blink pattern of the user.

In order to determine an optimum condition under which the eye blink pattern is driven by analyzing the photographed image, the subliminal driver 50 of the display device may further include a pattern analyzing unit 53.

In summary, when a subliminal image is compulsorily inserted, displeasure may be caused to a user. In order to solve the problem, the number of times of eye blink may be recognized by using a camera, and when the number of times of eye blink of a user is decreased, a subliminal function may be selectively driven. However, for a monitor or a TV, costs for mounting a camera may be additionally generated, and power consumption may be increased according to an increase in an image processing amount.

According to the present invention, when the number of times of input of a user event per unit time is equal to or greater than a reference value, a subliminal image may be displayed, thereby inferring concentration of a user with a simple algorithm and implementing the subliminal function.

Further, because a camera is not essentially required, manufacturing cost is low, and power consumption according to an increase in an image processing amount is not increased.

Further, a driving condition of a subliminal function may be set according to an individual user, thereby decreasing displeasure of the user and increasing a subliminal effect.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A method of driving a display device, comprising:
counting the number of times of input of a user event;
calculating an event input rate defined as the number of times of input of the user event per unit time; and
displaying a subliminal image when the event input rate is equal to or greater than a first reference value.

2. The method of claim 1, further comprising:
displaying the subliminal image when the user event is a drag input, and a drag time, for which the drag input is maintained, is equal to or greater than a second reference value.

3. The method of claim 2, further comprising:
detecting an eye blink pattern of a user by using an imaging unit;
counting the number of times of eye blink based on the eye blink pattern of the user;
calculating an eye blink rate defined as the number of times of eye blink per unit time; and
setting the event input rate pre-calculated based on a time, at which the eye blink rate is equal to or less than a third reference value, as the first reference value.

4. The method of claim 3, further comprising:
setting the drag time pre-calculated based on a time, at which the eye blink rate is equal to or less than the third reference value, as the second reference value when the user event is a drag input.

5. The method of claim 1, wherein the user event comprises at least one of a touch input through a touch screen, a keyboard input through a keyboard, and a mouse input through a mouse.

6. The method of claim 1, wherein the subliminal image comprises an image for inducing eye blink of a user.

7. The method of claim 1, wherein the subliminal image is displayed on a predetermined region or an event generation region, in which the user event is generated, on a screen.

8. The method of claim 1, wherein the subliminal image overlaps or is combined with a normal image to be displayed.

9. The method of claim 1, wherein the subliminal image is displayed for a predetermined time at a predetermined period.

10. A display device, comprising:
a display unit;
a user input unit configured to generate a user event; and
a subliminal driver configured to count the number of times of input of the user event, calculate an event input rate that is the number of times of input of the user event per unit time, and display a subliminal image on the display unit when the event input rate is equal to or greater than a first reference value.
